(19) United States
(12) Patent Application Publication
(10) Pub. No.: US 2012/0166268 A1
(43) Pub. Date: Jun. 28, 2012

(54) TIME TO BUY

(75) Inventor: DANIEL G. GRIFFITHS, Bellingham, MA (US)

(73) Assignee: EXCLUSIVE CONCEPTS, Burlington, MA (US)

(21) Appl. No.: 13/234,930

(22) Filed: Sep. 16, 2011

Related U.S. Application Data
(60) Provisional application No. 61/426,722, filed on Dec. 23, 2010.

(51) Int. Cl. G06Q 30/00

(52) U.S. Cl. 705/14.23

(57) ABSTRACT

An electronic method is provided to convert an online consumer into a purchaser, therefore decreasing shopping cart and website abandonment, by making a time sensitive offer based on that consumer's behavior to incentivize the consumer to complete their offer.

### CROSS-REFERENCE TO RELATED APPLICATION

This patent application claims priority to U.S. Provisional Application Ser. No. 61/426,722 filed in the United States Patent and Trademark Office on Dec. 23, 2010 by Daniel G. Griffiths, which is hereby incorporated by reference in its entirety.

### TECHNICAL FIELD

This invention relates generally to the utilization of an online consumer's behavior to convert the consumer into a purchaser and more particularly this invention relates to a method for making a time sensitive offer based on that online consumer's behavior.

### BACKGROUND

Retail shopping websites are popular with consumers because the consumers can shop at home from the convenience of their home computer, obtain sizes, quantities, and colors of items that a store may not carry, and eliminate the hassle of dealing with other shoppers and store clerks. Retail shopping gives the consumer a lot of power because the consumer can search vast databases of offered goods and services, compare prices, features, customer reviews, and then purchase selected products in a simple online checkout transaction.

An issue in online shopping is that consumers frequently browse products but leave a website without starting a purchase, or they select products, place them in their shopping carts, and never checkout the items, thus abandoning their shopping carts and the website. Numerous factors may contribute to the hesitation of a consumer to purchase their selected products, including wanting to obtain a better price on the product from an alternative website, hoping that the selected product will go on sale at a later point in time, wanting to inspect the product in person instead of purchasing it online, and forgetting that products were selected and remain in their shopping carts.

The detriments to a business of having consumers place products into their shopping carts and fail to complete the sale results in a significant cost to the retailer. Consumer abandonment of an online purchase, or abandonment of the website, is of serious concern to online merchants.

Some estimates indicate that shopping cart abandonment causes over sixty percent of potential online sales to be lost. Therefore, reducing the number of shopping carts and websites abandoned by converting online consumers into purchasers would greatly benefit online merchants.

Additionally, coupon distribution is widely used as a method for marketing products and persuading a consumer to spend at a particular retailer, including online retailers. A consumer can receive coupons and special sales offers that expire after a set time and typically a consumer needs to keep track of these incentives in order to benefit from the offers before their expiration. Furthermore, for a consumer to utilize an online coupon, the consumer will have to enter the promotion code at the checkout of their products. The passive and interruptive nature of print coupons, coupons conveyed over email, and other traditional coupon mediums results in incentives often being bypassed, “tuned out,” or altogether ignored because the consumer needs to keep track of the coupons, heed the expiration dates, or recall promotion codes to be entered in at checkout. Thus, there is a need in the art for a system which provides an online shopper with an incentive to purchase items which have been added to an online shopping cart.

### SUMMARY OF THE INVENTION

The present invention provides a system and method of offering a time-sensitive incentive for a consumer to purchase a product online.

The invention provides a system and method for giving a consumer an incentive to purchase a product online. When a consumer considers products online, they may perform a number of actions, such as browsing to a product page, adding a product to an online shopping cart, or browsing to or away from a checkout page. Systems and methods of the invention allow any one or combination of these actions to be defined as a trigger. Systems and methods of the invention may include monitoring the consumer's actions online, and responding to a trigger by offering an incentive to make a purchase. The incentive may include a discount which will be applied to the consumer's purchase if the consumer performs a product purchase transaction—such as agreeing to purchase the item—within a set amount of time. Offering the incentive can include displaying information pertinent to the incentive on a screen visible to the consumer. The availability of the incentive may expire after a set amount of time. The displayed information can include a countdown timer indicating the expiration of the incentive. Systems and methods of the invention allow a merchant to configure a variety of parameters affecting the incentive and how it is offered to the consumer. In one illustrative embodiment of the invention, when a consumer adds a product to an online shopping cart, a module of the invention causes a display to appear which contains text which reads “Buy this product within ten minutes and receive 10% off.”

In one embodiment of the invention, a merchant may control parameters that affect whether and when an incentive will be offered, as well as parameters affecting the timing, value, and nature of the incentive. The merchant may choose different amounts of time or different discounts or a discount that changes as time elapses or any number of other incentive offer variations. The incentive can be displayed to the consumer in response to the consumer's behavior. For example, the incentive can be displayed in response to certain triggering behaviors which may include: adding a product to a shopping cart; browsing away from a certain web page; or clicking a link or button displayed by a web browser.

In one aspect of the invention, the invention relates to an electronic method of displaying a time sensitive offer based on online browsing behavior. The method includes monitoring the online shopping actions of a consumer. The method further includes providing for a message to be displayed to a consumer, for instance by invoking a pop up on a current page being visited by the consumer. The message may ask the consumer to complete an order within a certain amount of time; and offer the consumer an incentive to complete the order within a certain amount of time.

In one embodiment according to this aspect of the invention, the message includes a timer that proceeds to countdown and may be displayed on any page visited by the consumer.

In one embodiment according to the invention, the message provides the consumer with information about when the offered incentive will expire.

In another embodiment according to this aspect of the invention, the message continues to appear on any page visited by the consumer until the consumer begins completion of their purchase in the checkout pages of the site.

In another embodiment according to this aspect of the invention, the incentive includes a coupon code automatically applied at checkout. In another embodiment according to this aspect of the invention, application of the incentive or use of the incentive's coupon code results in at least one or more of the following: a set percentage off their order; a free item with the purchase of their order; a coupon to be received at a later date; and/or a percentage off their order that decreases as the consumer takes longer to complete their order.

In another embodiment according to this aspect of the invention, a notification is provided to the consumer that the incentive has been applied to the purchase.

In another embodiment according to this aspect of the invention, monitoring the action of the consumer includes ascertaining the frequency of visits by the consumer to any page visited by the consumer. In another embodiment according to this aspect of the invention, the monitoring includes ascertaining the amount that the consumer spent during previous visits to any page. In another embodiment according to this aspect of the invention, the monitoring is performed by a tracking engine.

In a second aspect according to the invention, the invention relates to an electronic method of encouraging a consumer to complete an online order. The method includes assessing online shopping actions of a consumer. The method further includes triggering a display after a set period of time to provide an incentive to the consumer, wherein the display includes a timer that indicates the remaining time for the consumer to take advantage of the incentive; and encouraging the consumer to complete their order in the set period of time so that the consumer can obtain the incentive.

In one embodiment according to this aspect of the invention, the online shopping actions of a consumer are monitored by a tracking engine configurable by a merchant.

In another embodiment according to this aspect of the invention, the triggering of the display after a set period of time is configurable by a merchant. In another embodiment according to this aspect of the invention, the display is provided to the consumer on a webpage configurable by a merchant.

In another embodiment according to this aspect of the invention, a merchant can configure the appearance of the display on a webpage, wherein the webpage is selected from at least one or more of the following: a homepage; a checkout page; a product page; a navigation page; and an information page.

In another embodiment according to this aspect of the invention, the timer remains visible to the consumer throughout an online shopping session.

In another embodiment according to this aspect of the invention, the incentive is configurable by a merchant.

In another embodiment according to this aspect of the invention, the incentive is selected from at least one or more of the following: a set percentage off their order; a free item with the purchase of their order; a coupon to be received at a later date; and a percentage off their order that decreases as the consumer takes longer to complete their order. It will be appreciated by one having skill in the art that the incentive is not limited to those examples listed here, but can include any number of other things. The incentive may include any product, service, discount, information, or other transaction arrangement which may tend to contribute to a consumer's likelihood of committing to purchase a product.

In a third aspect according to the invention, the invention relates to an electronic method of encouraging a consumer to complete an online order, the method includes triggering the display of information pertaining to an incentive when the consumer visits a pre-defined product page. The method further includes triggering the incentive in a display after the consumer visits the predefined product page, wherein the display may include a timer that indicates the remaining time for the consumer to take advantage of the incentive, and encouraging the consumer to complete their order in the remaining time so that the consumer can obtain the incentive.

In one embodiment according to this aspect of the invention, the predefined trigger page is configurable by a merchant.

In another embodiment according to this aspect of the invention, the incentive is configurable by a merchant.

### BRIEF DESCRIPTION OF DRAWINGS

FIG. 1 is a block diagram of an embodiment of an electronic method of displaying a time sensitive offer.

FIG. 2 is a block diagram of an alternate embodiment of an electronic method of displaying a time sensitive offer.

FIG. 3 is a block diagram of another embodiment of an electronic method of displaying a time sensitive offer.

FIG. 4 is a screenshot of an embodiment of an electronic method of displaying a time sensitive offer on a product page.

FIG. 5 is a screenshot of an embodiment of an electronic method of displaying the bottom part of a ship/bill page with a discount applied.

FIG. 6 is a screenshot of an embodiment of an electronic method of displaying a completed purchase with a discount applied.

FIG. 7 is a screenshot of an embodiment of software to set website configurations for displaying a time sensitive offer.

### DESCRIPTION

In general, the present disclosure is applicable to online platforms and hosting solutions including online merchants who have online stores. A consumer may visit an online store looking for a specific item or to browse the products offered by the online store. By using a tracking monitor or tracking engine provided by the present invention, certain actions or combinations of actions of the consumer can be pre-defined to act as a trigger.

Responsive to the trigger, an incentive can be offered to the consumer. Depending upon configurations specific to that online store, once a consumer performs the predefined trigger or set of multiple triggers, (depending upon the configuration), information can be presented to the consumer, for example, in a pop-up window or other display form. The displayed information can ask the consumer to complete their order and can offer the consumer an incentive—for instance, in the form of a coupon, discount, or other promotion—which will be applied to their purchase if the consumer performs a product purchase transaction within a certain amount of time. Depending on the particular online store, the consumer may complete their purchase (i.e., perform a product purchase transaction) in any number of ways, including, for example: one-click buying; clicking on the “check out” button; browsing to a shipping and billing page; affirming an agreement to buy; or otherwise causing the product to be purchased or ordered. In one embodiment of the invention, the displayed information includes a countdown to zero, after which the coupon or promotion is expired. If the consumer chooses to complete their purchase within the allotted time, the incentive automatically applies at checkout and the consumer is notified that the incentive offered has been applied to their purchase.

The present invention provides a system and method for giving a consumer an incentive to purchase a product online by performing a product purchase transaction. In some online shopping environments, purchasing a product may comprise a number of related steps or transactions, such as; clicking a “checkout” button; accessing a ‘ship-bill’ page; confirming a payment method; affirming an agreement to buy; and/or another finalizing transaction. Accordingly, in one embodiment of the invention, a product purchase transaction is one of those steps, for instance that step in which a consumer commits to making a purchase or otherwise indicates a likelihood of ordering. For instance, the present invention can give a consumer an incentive to perform a product purchase transaction which is defined as clicking on a “checkout now” button. In an alternative embodiment of the invention, two or more different product purchase transactions could be defined, each of which cause the incentive to be applied—for example, clicking a “one-click ordering” button or clicking a “checkout” button. In one embodiment of the invention, a merchant defines what action or combination of actions will constitute the product purchase transaction which invoke the application of the incentive.

In one embodiment, systems and methods of the invention can operate with “global”, or “whole-website”, scope. For example, a merchant may configure the tracking engine to assess a consumer's visits to, and actions within, a large number of different web-pages within the merchant's online store. In this embodiment, the tracking engine logs the various web-pages within an online store that a consumer visits. Once the consumer has reached a threshold of a number of pages, the tracking engine triggers an incentive to be displayed to the consumer, along with a certain amount of time that the consumer has to complete their purchase.

When the threshold number of pages has been reached, information about the incentive is displayed and a timer is shown in the display and activated. The timer then begins a countdown. The countdown can proceed while the consumer does other things such as browse other pages within the online store, look at unrelated material on the computer, or even walk away from the computer. In one embodiment, the countdown timer is displayed on each page within the online store while the consumer browses within the online store.

While the consumer continues to browse the online store, the timer in the display continues to countdown and appears on each page that the consumer visits until either the consumer completes their purchase at the checkout page or until time runs out and the incentive is expired. If the consumer chooses to complete the purchase within the allotted time, the incentive automatically applies at checkout and the consumer is notified.

In an alternative embodiment, systems and methods of the invention can operate in response to a single action within a website or online store. In this embodiment, the merchant may configure the tracking engine to respond to a single action by a consumer, such as visiting a predetermined trigger page. In this embodiment, the consumer's actions are not being cumulatively tracked or monitored but, rather, an incentive is applied simply because the consumer performed the single action. For example, the single triggering action can be visiting a trigger page or any other single action, such as: clicking “add to cart” while viewing a product page; browsing to a checkout page; browsing away from a checkout page; or changing a quantity in a shopping cart. Once the consumer performs the single triggering action, regardless of any other consumer activity, information is displayed to the consumer offering an incentive that can be used if they make a purchase within a set amount of time.

In an embodiment of the invention, a merchant associated with an online store may configure the nature and value of the incentive, the way it is presented to a consumer, or the way in which it is triggered. The merchant may use the software of the present invention to set numerous parameters for the incentive to apply. For example, the parameters that can be set by the merchant may pertain to the consumer actions which trigger the incentive to be offered, and may include but are not limited to: what actions by the consumer constitute the trigger (e.g. number of product page views or number of items added to the cart); the number of product pages the consumer needs to visit in order for the trigger to apply; whether the consumer is a registered user of the online store; the status of a consumer's participation in a rewards program associated with the online store; recent changes in a consumer's regular purchasing volume; a consumer's status as a new user or established purchasing history. The merchant can also set parameters affecting the nature of the incentive itself, which may include: the amount of time remaining for the sale to be complete in order for the incentive to apply; shipping upgrade; points that can be redeemed within a rewards program; a “cash back” incentive; or the discount offered (e.g. a certain percentage off the total order, a coupon code that can be entered by the consumer, etc). The merchant can further configure information seen by the consumer, such as, for example, the appearance of the offer, the location of the offer on the screen, whether or not the offer remains visible during the time that the offer is counted down, and whether or not the consumer has the control to minimize or remove the offer's appearance on a webpage.

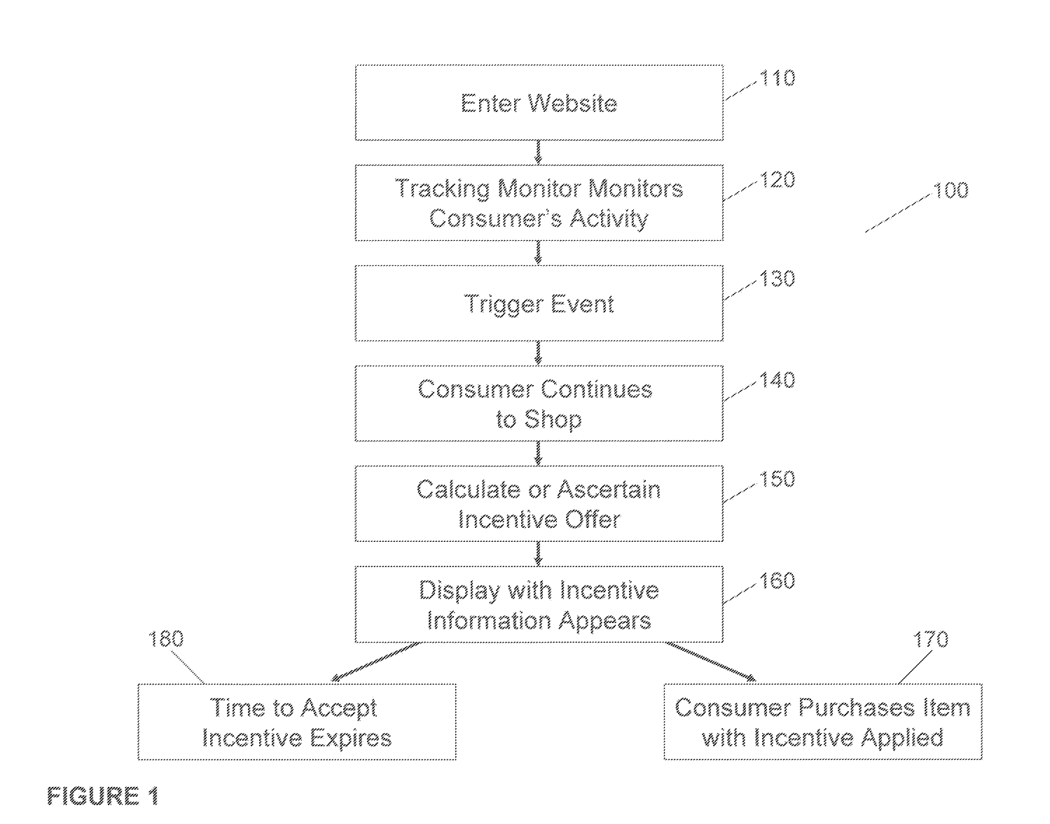

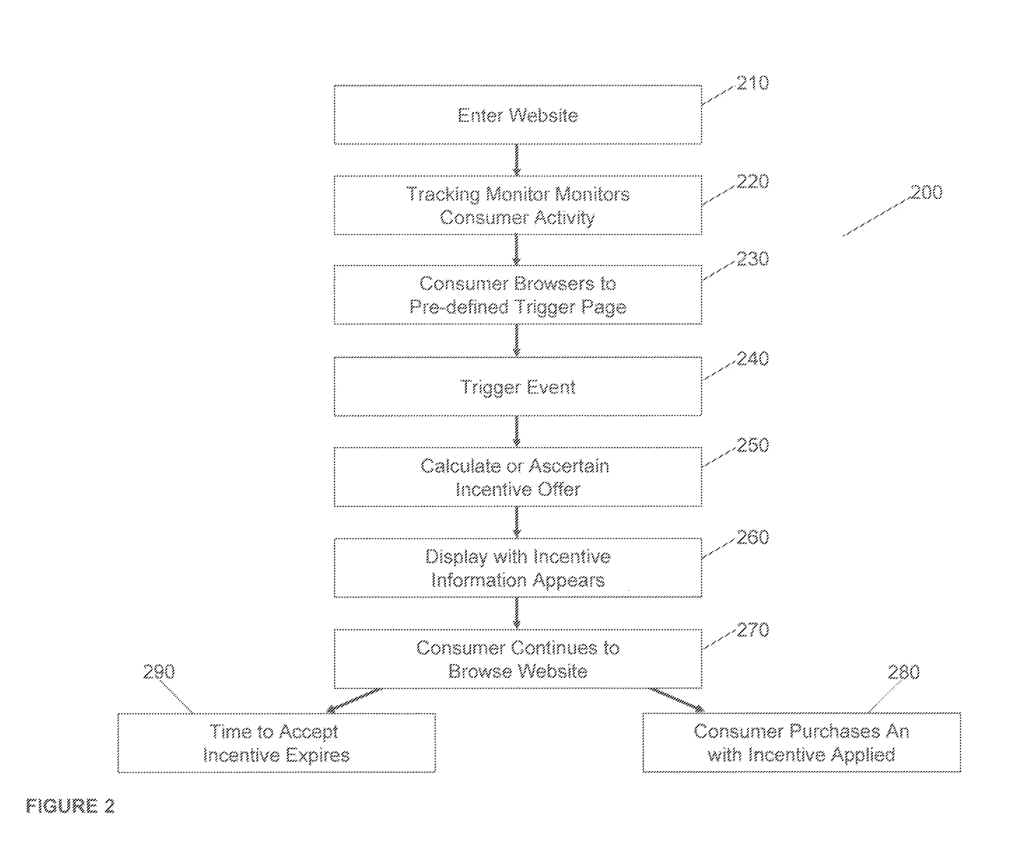

Referring to FIG. 1, in one embodiment according to the invention, an electronic method 100 of displaying a time sensitive offer on a product page is shown. When a consumer enters the website 110 of the online retailer, the tracking monitor 120 begins to evaluate that consumer's activity. Once the trigger event 130 is triggered and the consumer continues to shop 140, the website configuration 150 calculates or ascertains an incentive offer. A display window with the incentive 160 appears on any or all webpages that are accessed by the consumer. Either the consumer will accept the incentive and purchase the item with the incentive applied 170 or the time to accept the incentive will expire 180.

A merchant provides website configurations 150 to calculate or use a predefined incentive offer. The display window with the incentive 160 is generated in one embodiment by JavaScript. When the consumer performs the triggering event, for example by returning to a product page after adding an item to a cart 140, the JavaScript causes the display window with the incentive 160 to appear. In alternative embodiments, various combinations of Adobe Flash and Flex, Sun's Java, or other mechanisms may be used to cause the display window with the incentive 160 to appear, as will be understood by those of skill in the art.

The tracking monitor 120 evaluates the pages and the products that the user is accessing while online. In one embodiment of the invention the tracking monitor uses HTTP cookies or “cookies”. A cookie is typically a small file of text sent by a web server to a World Wide Web (WWW) browser. The cookie is later sent back to the server by the browser (e.g., when the browser again accesses the server). HTTP cookies may be used for user authentication, user tracking, and maintaining user-specific information. The cookie can be set to specify a date or time of expiration, in which case the cookie will be deleted on that date or time. Cookies can be used for tracking the browsing of a user. Based on the configurations set by the merchant, the consumer will then be offered an incentive to complete their purchase.

FIG. 2 is an alternate embodiment according to the invention, where an electronic method 200 of displaying a time sensitive offer is shown. When a consumer enters a website 210 of an online retailer the tracking monitor 220 begins to evaluate that consumer's activity. In this embodiment, a merchant has configured a specific page to act as a “trigger” page. When a consumer enters the predetermined trigger page 230, methods of the invention recognize the entry 230 as the trigger event 240. This results in the display of an incentive offer 250 based on the preset website configurations. The incentive 260 appears displayed on a webpage visible to the consumer. While the consumer continues to browse the website 270, the incentive will remain displayed on the screen, or alternatively the consumer may minimize or close the display of the incentive. Either the consumer will ultimately purchase the product within the allotted time, thereby causing the incentive to be applied 280, or the time to accept the incentive will expire 290.

The tracking monitor 220 evaluates the pages and the products that the user is accessing while online. In one embodiment of the invention the tracking monitor refers to HTTP cookies or “cookies”. In one embodiment, systems or modules of the invention cause information to be displayed requesting that the consumer enable cookies and/or notifying the consumer that incentives are available if cookies are enabled.

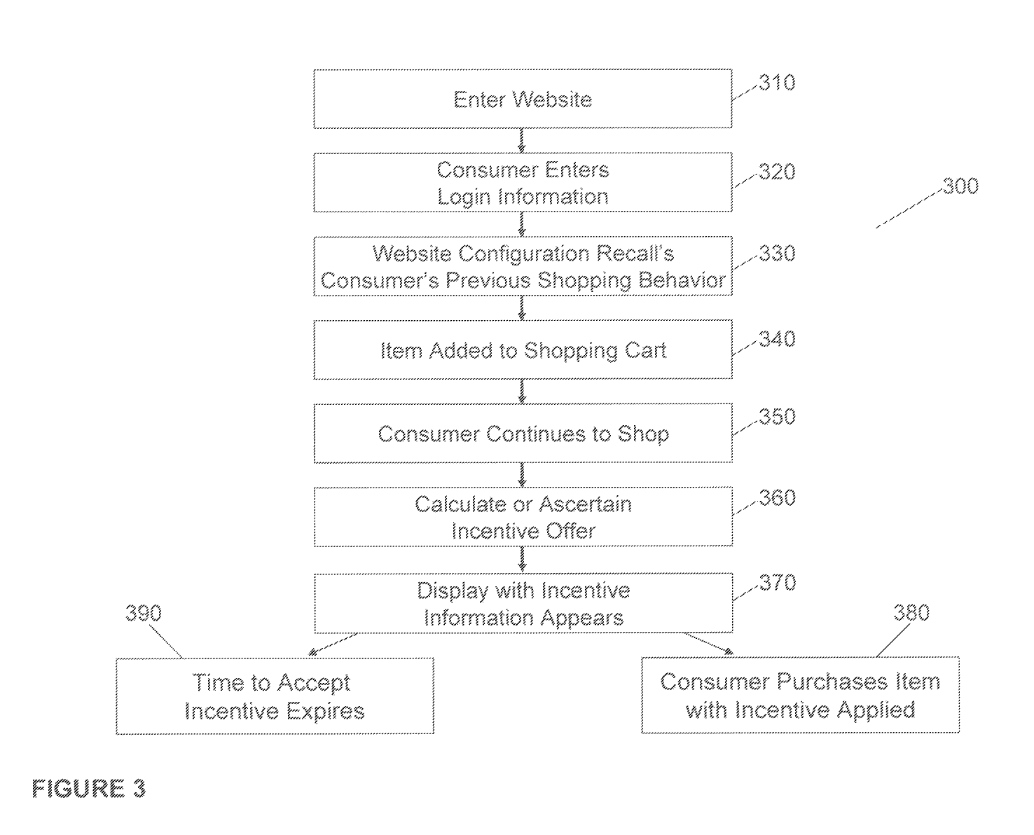

Referring to FIG. 3, in another embodiment according to the invention, an electronic method 300 of displaying a time sensitive offer on a product page is shown. When a consumer enters the website 310 of the online retailer, the consumer will be prompted to enter in their login information 320. The website configuration 330 will recall that consumer's previous shopping behavior for the online retailer. Once the consumer adds an item to their shopping cart 340 and the consumer returns to the site and continues to shop 350, the website configuration 360 calculates or ascertains an incentive offer. Information pertinent to the incentive can appear 370, for instance in a display window on the current webpage. Either the consumer will accept the incentive offer and purchase the item within the allotted time, to get the incentive offer applied 380 or the time to accept the incentive offer will expire 390.

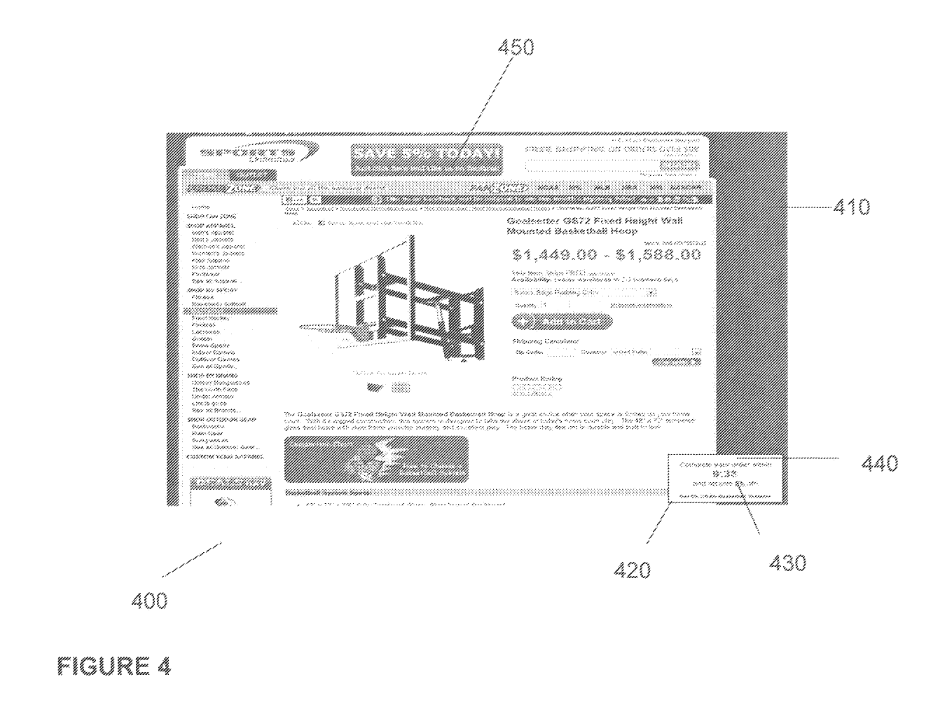

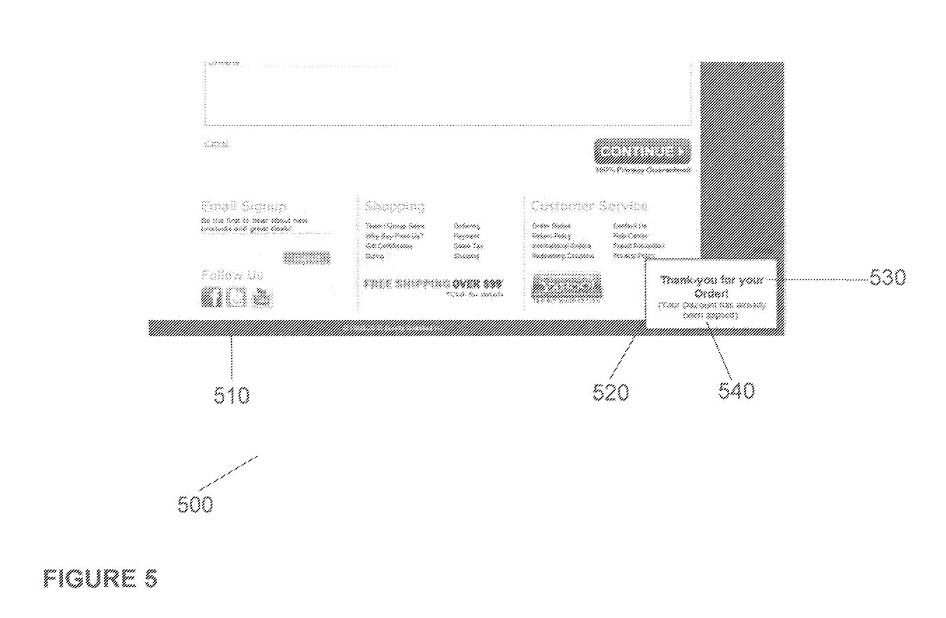

Referring to FIG. 4, in one embodiment according to the invention, an electronic method 400 of displaying a time sensitive offer on a product page is shown. A consumer may access an online store and view a web-page 410 that displays a product 450 that is available for a consumer to purchase. When the consumer performs a triggering event—which may, for example, include browsing to a product page 410 or adding product 450 to a cart—methods of the invention cause a display area 420 to appear. A display area may optionally be a window as drawn by an operating system, for instance, by invoking an application programming interface (API), or it may alternatively be any area displaying information, for example, any display as coded in or invoked by Java, Flash, a markup language, an app, a browser plug-in, or a scripting language. In this embodiment, display area 420 includes an incentive offer 430 and a timer 440. Display area 420 informs the consumer that the incentive offer 430 will apply if the consumer completes their order within the time shown on timer 440. The display area 420 may present an incentive offer 430 that is specific for that consumer. The consumer is allotted a specific amount of time that is indicated by the timer 440 that counts down the remaining time for the consumer to obtain the stated incentive offer 430 on their purchase.

The display area 420 can be configured so that once it appears, it remains visible on any webpage 410 which the consumer visits. Alternatively, display area 420 can be configured so that it is either minimized or hidden, for example, responsive to a predetermined condition or user input. Alternatively, display area 420 can be configured to show only on predefined pages, so that the consumer may see it in certain contexts, while they continue to browse in the online store. The timing, persistence, consumer control, and placement of display area 420 can be extensively configured by a merchant, and one skilled in the art will readily recognize other possible configurations.

Display area 420 can offer the consumer a valuable incentive, such as a predefined discount, if they complete their purchase within the set period of time. In one embodiment, countdown timer 440 in display area 420 creates in the consumer a sense of urgency. Thus, display area 420 presents to a consumer a visual incentive to complete their purchase by promising a pre-defined discount if the purchase is completed within the allotted time.

Referring to FIG. 5, in one embodiment according to the invention, an electronic method 500 of displaying information pertinent to a time sensitive offer can include displaying display area 520 on ship-bill webpage 510. In one embodiment, the ship-bill webpage 510 precedes submission or completion of the order. In this embodiment, the ship-bill webpage 510 allows a consumer to choose a shipping method and to enter billing information. The ship-bill webpage 510 can include information associated with one or more products which a consumer has in their online shopping cart. In this embodiment, the ship-bill webpage 510 includes a display area 520 containing a message 530. Message 530 can include a statement that a statement that the offered incentive has been applied to the order, a thank-you message, or any other message pertinent to an online sales transaction.

Information about the incentive, such as a confirmation that it applies to an order, can be displayed in various ways, places, and times during a consumer transaction. For instance, a ship-bill page can display information to a consumer anywhere within its text or displays. For instance, the ship-bill page or any other page shown can display a billing price which reflects the application of the incentive. In one embodiment of the invention, a product is listed with a line struck through the original price and a discounted price displayed nearby (i.e., elsewhere on the computer screen, in a display area, or pop-up window). Additionally or alternatively, after a consumer has navigated to the ‘ship-bill’ page or a similar page they can receive a confirmation that the incentive will be applied to their order. Additionally or alternatively, display area 520 can be shown, either persistently, periodically, or once, for instance. Display area 520 can include message 530, which can state that the incentive 540 was applied. One skilled in the art will appreciate that either or both of the ship-bill (or similar) page 510 and the display area 520 will show the consumer information pertinent to the incentive.

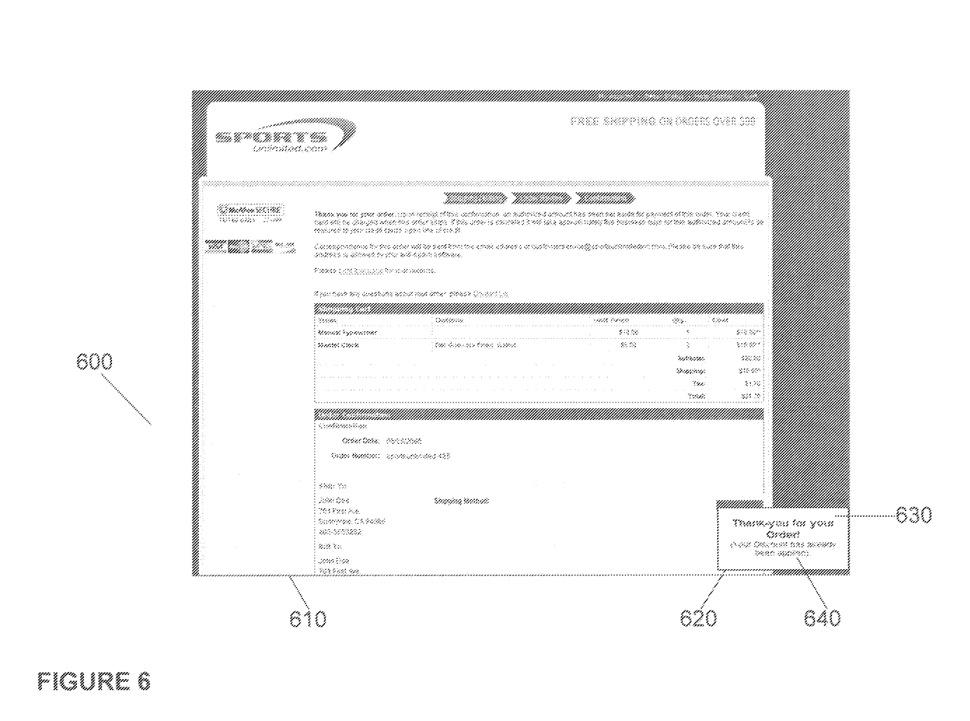

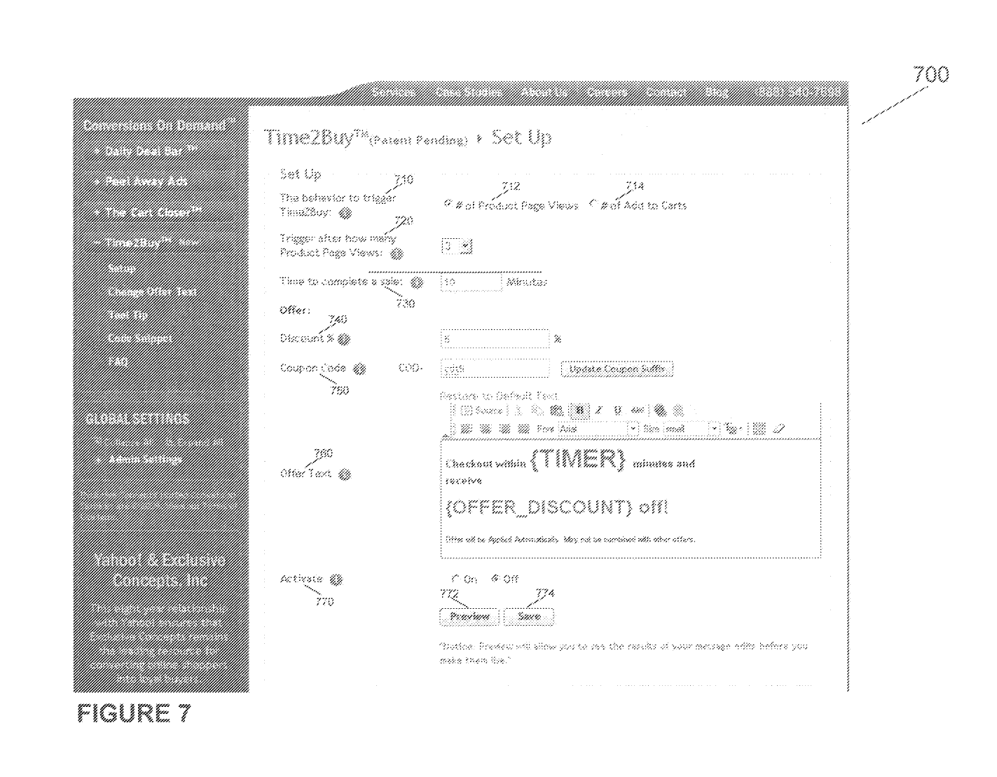

Referring to FIG. 6, in one embodiment according to the invention, an electronic method 600 of displaying information pertinent to a time-sensitive offer includes an order confirmation webpage 610 that is displayed at the completion of a purchase of items by a consumer. The order confirmation webpage 610 includes a display area 620 containing a message 630. Message 630 can state that the order has been completed and that a completed incentive offer 640 has been applied to the order. A merchant can configure the invention to use any language in any message, including, to illustrate, a statement that an incentive offer has been applied, that a discount has been applied, or that a coupon has been applied, or even to deliver a thank-you message, or to encourage the consumer to consider further shopping.

Information pertinent to an incentive 640 can be displayed in display area 620, within the text, images, or body of order confirmation webpage 610, or by other means, such as a pop-up window, scroll bar, audio sound, email message, animation, or other text or graphic display. For instance, when the consumer is navigated to the order confirmation webpage 610 they can receive a confirmation that the incentive was applied to their order. This may, for instance, be reflected in the price they are given, or the confirmation may appear, for instance, as a line-item within the shopping cart subtotal accounting. Additionally or alternatively, the confirmation may be displayed as other text or graphics on order confirmation webpage 610. Additionally or alternatively, the consumer may also be shown the display area 620 with the message 630 that the incentive offer 640 was applied. Accordingly, either or both of the order confirmation webpage 610 and the display window 620 will show the consumer that the incentive was added to their order.

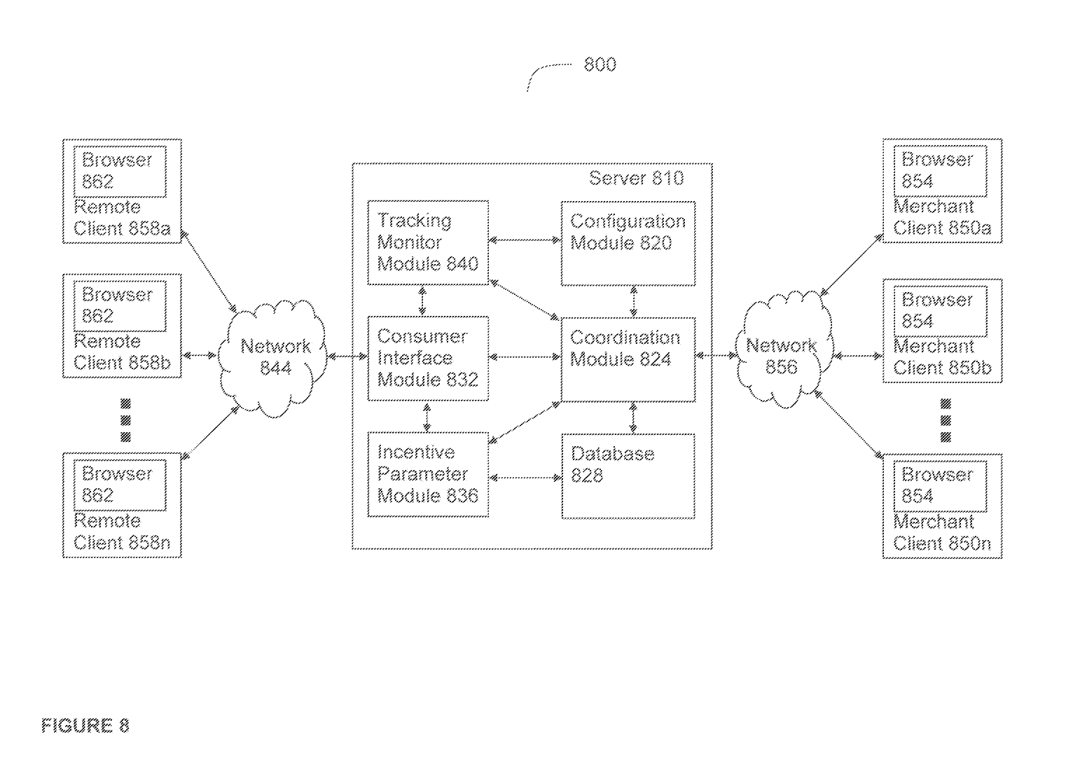

Referring to FIG. 7, in one embodiment according to the invention, a merchant can use an interface 700 to configure the implementation of a time-sensitive offer. In one embodiment, interface 700 is a webpage displayed in a browser. In an alternative embodiment, interface 700 can be supplied by a dedicated application or “app”, a form to be filled out, a widget or other executable content. In an alternative embodiment, a merchant chooses or uses a pre-defined set of parameter values. To configure the parameters using interface 700 according to one embodiment of the invention, a merchant logs on to software and accesses interface 700 to customize an incentive that is offered to their consumers.

The interface allows the merchant to choose what behavior will trigger 710 the offer of the incentive. For instance, in one embodiment of the invention, the merchant can choose for the trigger to be either a number of product page views 712 or a number of times that “add to cart” was pressed by a consumer during shopping 714. Methods of the invention are not limited to these examples illustrated in FIG. 7, and a merchant could also choose checkout-page views, or some other action, to operate as a trigger.

Once the merchant chooses what behavior will trigger 710 the offer of the incentive, the merchant can then choose what number of instances of that behavior will constitute a trigger 720. In the example displayed in FIG. 7, a merchant has chosen that the triggering behavior 710 will be a number of product page views 712, and that the number of page views that will operate to trigger the incentive 720 will be three. This is only an illustrative example, and other triggering behaviors can be presented in interface 700, and any number of instances could be chosen.

Interface 700 can allow a merchant to set the time to complete the sale 730 once the incentive is triggered. In this example, once the incentive is triggered, the merchant has set the time to complete the sale 730 to allow the consumer ten minutes to complete their purchase in order to obtain the offered incentive.

Interface 700 can allow a merchant to define the incentive which will be offered to a consumer. In one embodiment of the invention, the merchant will offer the consumer a discount, and will use interface 700 to set a discount percentage 740 that will be offered. In alternative embodiments of the invention, the incentive can be something else which increases the likelihood that a consumer will commit to buy, including, for instance: a dollar-off amount; a shipping upgrade; a free product; points or “miles” in a rewards program; information; or other value. In one embodiment of the invention, the incentive—be it a discount percentage or other value—is provided through the mechanism of supplying a coupon code. In an alternative embodiment of the invention, the incentive is provided through systems and methods of the invention without using a coupon or coupon code mechanism. For instance, computer program instructions stored on a computer readable medium can, when executed, cause a purchase price for an item to be modified within a database, data file, or table or, alternatively, can cause a numerical value to be stored—in a variable, table, or file—representing a discount percentage or dollar amount which will be applied to a purchase price during a stage of a purchase or order transaction. One skilled in the art would recognize that other mechanisms of implementing the incentive are possible and that the mechanisms discussed here are only illustrative examples.

Interface 700 can allow a merchant to supply a coupon code 750 to a consumer. In one embodiment of the invention, the merchant establishes the coupon code within their own e-commerce software, and uses systems or methods of the present invention to cause the code to be displayed to a consumer. In an alternative embodiment of the invention, a coupon code originates with a third-party, for instance, pursuant to a business agreement between a merchant and the third party.

Interface 700 can allow a merchant to offer an incentive such as a discount 740 and a coupon code 750 both, or each separately, or only one or the other. In one embodiment of the invention, the coupon code is the sole incentive offered. In another embodiment, the discount is the sole incentive offered. In another embodiment, a discount and/or a coupon code may be offered in conjunction with each other or with any other incentive. In one embodiment, a coupon code or a discount can be offered to the consumer in the alternative.

In one embodiment of the invention, interface 700 can allow a merchant to control the appearance of any display of the incentive offer. For instance, once the merchant selects the triggers and discounts that will be offered to the consumer, the merchant can choose to alter the offer text 760, such as font, font size, content, layout, etc. In one embodiment of the invention, interface 700 can allow a merchant to review and implement the methods and systems of the invention. For instance, after setting other applicable parameters, the merchant can preview 772 the offer before it is displayed, and/or save 774 the settings of the trigger and offer. In one embodiment of the invention, a merchant can toggle a pair of radio buttons to “on”, thereby activating 770 the offer.

Referring to FIG. 8, in one embodiment according to the invention, the invention provides a system 800 for encouraging a consumer to complete an online order. The system can optionally include: at least one server 810; a configuration module 820; a coordination module 824; a database 828; an incentive parameter module 836, a consumer interface module 832; a tracking monitor module 840; one or more merchant clients 850a, 850b, . . . , 850n, wherein any one of the aforementioned can be communicatively coupled to at least one of remote client 858a, 858b, . . . , 858n, for instance, by network 844. In one exemplary embodiment, each of configuration module 820, coordination module 824, database 828, incentive parameter module 836, consumer interface module 832, and tracking monitor module 840 are located on a server 810. In an alternative embodiment, any or all of these modules are located in any combination on any of a plurality of servers or computers. In one exemplary embodiment, each of the one or more merchant clients 850a, 850b, . . . , 850n are communicatively coupled to any of the aforementioned by network 856. In an alternative embodiment, any or all of the one or more merchant clients 850a, 850b, . . . , 850n are integrated into system 800 along with any or all of configuration module 820, coordination module 824, database 828, incentive parameter module 836, consumer interface module 832, and tracking monitor module 840, for instance, in an alternative embodiment in which these components are part of a single computer, such as a laptop, desktop, handheld device, or server computer with remote terminal. In one exemplary embodiment according to system 800, a consumer accesses system 800 through a remote client 858, for instance through a browser 862. In one exemplary embodiment according to system 800, a merchant accesses system 800 through a merchant client 850, for instance, through browser 854.

In one embodiment, the invention provides a system of giving a consumer an incentive to perform a product purchase transaction online, the system comprising: a server 810 including a configuration module 820. A merchant can access the server 810 through a client 850 and can use a configuration module 820 to define a triggering event. The triggering event can comprise at least one action performable on a remote client 858 by a consumer. A tracking monitor module 840 can supply a tracking monitor to monitor one or more actions performed on the remote client by the consumer. The tracking monitor can detect the triggering event, causing system 800 to respond. The response can include causing an incentive parameter module can calculate or ascertain an incentive. Information pertinent to the incentive can be stored in database 828. A coordination module 824 can synchronize the modules of system 800 to achieve the desired results. A consumer interface module 832 can cause information pertinent to the incentive to be displayed on the remote client 858. A coordination module 824 can apply the incentive to a purchase. Remote client 858 can include a display, for instance, a monitor or screen, and in one embodiment of the invention, an area of a web browser displayed on the monitor or screen. The display, for instance, web browser 862, can include any information, for instance a timer which can optionally display a countdown. Web browser 862 can, according to one embodiment, display any web page and can optionally display a display area over or integrated into such a webpage. A display area or any information can be displayed on any web page for any amount of time, as, for example, caused by coordination module 824 and/or consumer interface module 832. In one embodiment of the invention, the system includes a coordination module 824 to cause an incentive to be applied to a purchase after a consumer makes a purchase within an allotted time, and a consumer interface module 832 delivers and retrieves all information, for example through network 844 and remote client 858, pertinent to the incentive. Responsive to input received via configuration module 820, incentive parameter module 820 can provide or ascertain, and database 828 can store, information pertinent to an incentive, wherein the incentive can include a coupon code automatically applied at a checkout. In one embodiment of the invention, the invention provides a system for offering a coupon code selected from the group consisting of: a set percentage off an order, a free item with the purchase of an order, a coupon to be received at a later date, and a percentage off an order that decreases as the consumer takes longer to complete their order. Consumer interface module 832 can notify a consumer that an incentive has been applied to a purchase. Tracking monitor module 840 can include a tracking monitor which can ascertain: whether a consumer visits a web page; the frequency of visits to any page; the number of visits to a page; the amount of time spent during one visit to a page; the cumulative amount of time spent visiting a page; and other similar events.

It is envisioned that the methods and systems according to the present disclosure can track or not track consumer's usage and provide a consumer an incentive based on that consumer's usage or preset conditions. The calculation of when the incentive offer is triggered and where the incentive offer is displayed is configurable by the merchant. In one embodiment according to the present disclosure a tracking engine monitors the consumer and when the consumer visits a specified number of webpages of the online store, the incentive is presented to the consumer. Factors that may contribute to the incentive offer being triggered may include the number of products the consumer looks at while browsing the online store, the number of times the consumer has visited that particular online store or certain pages on the store site, the number of products the consumer has previously purchased from the online store, by visiting a predetermined product page, and the total amount the consumer has previously spent at the online store.

It is envisioned that the methods and systems according to the present disclosure provides that the merchant can configure what incentive is provided to the consumer. Methods and systems of the invention can display information pertinent to the incentive. Information pertinent to the incentive can include any text, graphic, or signal which may tend to reveal at least an aspect of the offer. Information pertinent to the incentive can include, for illustration: an amount of a discount; an amount of time; an expiration time; a coupon code; a consumer's information; identifying information; a company name; a dollar amount; a countdown timer; window controls, for instance to maximize, minimize, or hide, or scroll bars; a button or link; text; a thank-you message; an exhortation to perform an action online; or other material.

Types of incentives or coupon codes that may be offered to the consumer include, but are not limited to: a set percentage off of the consumer's total order; a free item with the purchase of the consumer's order; a coupon to be received by the consumer at a later date; and a percentage off the consumer's total order that decreases as the consumer takes a longer time to complete their order.

A tracking monitor or a tracking engine can monitor a consumer's activity and information and can determine what type of incentive is offered and/or how it is offered, based on that activity. For instance, a tracking engine or a merchant can monitor the number of product pages the consumer visits during an individual visit to the online store or any other activity or set of activities that a consumer performs. For example, the tracking engine can monitor the number of times that the “add to cart” button is pressed. Additionally or alternatively, when a consumer logs in to an online store, the store can recognize a username, email address, shipping address, credit card information, etc. of the consumer. Any piece or combination of any of this information or the results of any monitoring activity can be the basis for choosing parameters of the incentive offer.

It is envisioned that the methods and systems according to the present disclosure provides for the merchant to also configure how much time remains for the consumer to complete their purchase with the preconfigured incentive. The amount of time allotted to the consumer to complete their purchase may be based on a number of factors including but not limited to: how many items the consumer has placed in their shopping cart; the number of times the “add to cart” button was clicked; the number of product pages the consumer has visited during this time at the online store; the volume of consumers visiting the online store on that particular day; the frequency or pattern of consumer acceptance of incentives; or any other piece or combination of any information or results from any monitoring activity.

In one embodiment of the invention, the timer remains active and visible to the consumer during their shopping session on the online retailer. The timer continually displays the amount of time remaining for the consumer to accept the offered incentive until either the consumer completes the purchase or until time expires. In one embodiment of the invention, the incentive changes as time passes. For instance, a percent discount can decrease as the timer counts down In one embodiment of the invention, when time runs out for the consumer, the consumer will receive, or alternatively not receive, a message that the incentive has expired and they are no longer eligible to accept the incentive.

Methods and systems of the invention provide highly configurable tools by which a merchant can cause an incentive to be offered to a consumer. In one embodiment of the invention, the consumer is a prospective online purchaser of a product. For instance, the consumer may have viewed information relating to a product by using a web browser, or the consumer may have added a product to an online shopping cart. The consumer may be unaware of the identity of the merchant, or indifferent. For instance, the consumer may think that a product can be purchased from an entity identified by a web site's domain name, but the product may in-fact be offered for sale by a third-party merchant. In one embodiment of the invention, the merchant hosts an online store. In an alternative embodiment, the merchant hosts an online store through a hosted e-commerce platform. In another alternative embodiment, a merchant hosts an online store by putting e-commerce software on a web host. In another alternative embodiment, a merchant hosts an online store through an internal server.

In one embodiment of the invention, the tracking monitor or tracking engine allows the online store or the online merchant to monitor the actions of the consumer. Actions which may be monitored include: inspecting a specific product; viewing other products offered by the online store; adding an item to an online shopping cart; or other actions performed by a consumer visiting an online store. For instance, the tracking monitor can monitor: mouse gestures or speed; visits to a particular page; attempts to a click on a particular link, button, or area of a page; duration of display of a particular page; gestures intended to browse away from a particular page; mouse-down events; mouse-up events; scrolling; scrolling at a certain speed or acceleration; entering text; changing text, for instance using a keyboard or pull-down menu, and wherein the text could be letters, numerals, or both; or any other interaction with a computer or electronic device. Methods of monitoring actions include: causing program code to be run in response to an action; incrementing a tally of number and/or times of performance of an action; placing, modifying, or deleting a cookie; updating a data file in a database supplied by the invention, wherein a log of a consumer's actions may be stored or encoded; or performing a logical operation which supplies a result which depends on the timing or performance of the action.

In one embodiment of the invention, an action or combination of actions constitute a trigger. Actions for the purpose of defining a trigger may include any action which can be monitored by a tracking monitor or tracking engine. Any action, or number of repetitions of an action, or combination of actions and/or repetitions can be predefined as all or part of a trigger. One skilled in the art will recognize that any of a wide variety of actions or combinations thereof can constitute the trigger.

In one embodiment, methods and systems of the invention comprise computer program code stored on a computer-readable medium which, when executed, can cause: a tracking engine or tracking monitor to monitor a consumer's activity; display an interface 700 to a merchant; display information pertinent to an incentive; apply an incentive to at least one aspect of a purchase transaction; display a timer; terminate the applicability of an incentive; respond to a consumer's interaction within an online store; perform another step or step described explicitly or inherently in this disclosure; and/or perform any combination of these events. The invention can cause information or interfaces to be displayed, to consumers, merchants, or other parties, in web browsers or in other applications, for instance including dedicated applications or “apps”—any of which can be displayed on computer screens or other electronic devices such as iPads, tablet computers, or smart phones. One skilled in the art will recognize that methods and systems of the invention can be implemented using any combination of programming languages, markup languages, development environments, or other software, firmware, or hardware products. For instance, the invention can be implemented to alternatively employ HTML5 or a Flash-style animation product depending on a user's context. In one embodiment, the invention includes a database, data file, table, or variable or variables, or any combination thereof, wherein information pertinent to a merchant, a consumer, a product, an incentive offer, or any other aspect of an online store or sales transaction can be written, stored, read, modified, or deleted. In one embodiment, the invention includes at least computer, for instance, a server computer, or any combination of computing devices and related devices and connections, including a WAN or LAN or the internet or other methods of connecting and communicating between or among computers as are commonly known in the art.

It will be understood that various modifications may be made to the embodiments disclosed herein. Therefore, the above description should not be construed as limiting, but merely as exemplifications of the various embodiments of the present disclosure. Those skilled in the art will envision other modifications within the scope and spirit of the claims appended hereto.

What is claimed is:

1. A method of giving a consumer an incentive to perform a product purchase transaction online, the method comprising:
defining a triggering event to comprise at least one action performable on a computing device by the consumer;
monitoring one or more actions performed on the computing device by the consumer;
responding to the triggering event;
causing information pertinent to the incentive to be displayed on the computing device; and
applying the incentive to the purchase.

2. The method according to claim 1, wherein the information pertinent to the incentive includes a timer display, wherein said timer display presents a countdown visible for its duration on any web page visited by the consumer.

3. The method according to claim 1, wherein the information pertinent to the incentive is displayed on any web page visited by the consumer until the consumer performs a second trigger event.

4. The method according to claim 1, wherein the incentive includes a coupon code automatically applied at a checkout.

5. The method according to claim 4, wherein the coupon code is selected from the group consisting of: a set percentage off their order, a free item with the purchase of their order, a coupon to be received at a later date, and a percentage off their order that decreases as the consumer takes longer to complete their order.

6. The method according to claim 1, wherein a notification is provided to the consumer that the incentive has been applied to the purchase.

7. The method according to claim 1, wherein the monitoring of the one or more actions performed by the consumer includes ascertaining the frequency of visits by the consumer to any page visited by the consumer.

8. The method according to claim 1, wherein the monitoring of the one or more actions performed by the consumer includes ascertaining the amount of time that the consumer spent during previous visits to any page.

9. The method according to claim 1, wherein the monitoring of the one or more actions performed by the consumer is performed by a tracking engine.

10. An electronic system for encouraging a consumer to complete an online order, the system comprising:
a tracking monitor configured to track the online actions of a consumer and detect a triggering event;
a consumer interface module configured to cause, responsive to a triggering event, a display to be presented to a consumer, wherein the display comprises information pertinent to an incentive;
a coordination module configured to apply, responsive to the consumer completing the online order within an allotted time, the incentive to the online order

11. The system of claim 10, wherein the tracking monitor is configurable by a merchant.

12. The system of claim 10, wherein the display is configurable by a merchant.

13. The system of claim 10, wherein the display is provided to the consumer on a webpage configurable by a merchant.

14. The system of claim 13, wherein the webpage is selected from the group consisting of: a homepage, a checkout page, a product page, a navigation page, and an information page.

15. The system of claim 10, wherein the information pertinent to the incentive comprises a timer, wherein the timer indicates a remaining time for the consumer to obtain the incentive.

16. The system of claim 10, wherein the incentive is configurable by a merchant.

17. The system of claim 16, wherein the incentive is selected from the group consisting of: a set percentage off their order, a free item with the purchase of their order, a coupon to be received at a later date, and a percentage off their order that decreases as the consumer takes longer to complete their order.

18. An electronic method of encouraging a consumer to complete an online order, the method comprising:
defining a trigger action, wherein the trigger action includes a computer interaction performed by a consumer;
monitoring computer use by the consumer;
displaying, responsive to the trigger action, information in a display area, wherein the information comprises an offer of an incentive and a duration of the offer; and
applying, responsive to the consumer completing the online order, the incentive to the online order.

19. The method of claim 18, wherein the trigger action is the action of viewing a web page.

20. The method of claim 18, wherein the incentive is configurable by a merchant.
